(19) United States
(12) Patent Application Publication
(10) Pub. No.: US 2025/0029617 A1
(43) Pub. Date: Jan. 23, 2025

(54) UTTERANCE SECTION CLASSIFICATION DEVICE, UTTERANCE SECTION CLASSIFICATION METHOD AND UTTERANCE SECTION CLASSIFICATION PROGRAM

(71) Applicant: NIPPON TELEGRAPH AND TELEPHONE CORPORATION, Tokyo (JP)

(72) Inventors: Takafumi HIKICHI, Tokyo (JP); Setsuo YAMADA, Tokyo (JP); Satoshi MIEDA, Tokyo (JP)

(73) Assignee: NIPPON TELEGRAPH AND TELEPHONE CORPORATION, Tokyo (JP)

(21) Appl. No.: 18/715,173

(22) PCT Filed: Dec. 3, 2021
(86) PCT No.: PCT/JP2021/044577

§ 371 Date: May 31, 2024

(51) Int. Cl. G10L 17/06; G10L 17/02; G10L 17/04

(52) U.S. Cl. CPC G10L 17/06; G10L 17/02; G10L 17/04

(57) ABSTRACT

A speech section classification device includes: a speech section estimation unit that estimates a speech section from speech text data including speeches of two or more people; a speech type estimation unit that estimates a speech type of each speech included in the speech section estimated by the speech section estimation unit; and a speech section classification unit that classifies the speech section estimated by the speech section estimation unit, using the speech type of each speech estimated by the speech type estimation unit and a speech section classification rule determined in advance as a rule for classifying speech sections on the basis of the speech type.

### TECHNICAL FIELD

The disclosed technology relates to a speech section classification device, a speech section classification method, and a speech section classification program.

### BACKGROUND ART

There is a technology of classifying speech sections included in a dialogue between two or more speakers, such as a dialogue between an operator and a client in a contact center and a dialogue between a sales representative and a client in face-to-face sales.

In a contact center, an activity of recording a dialogue between an operator and a client, analyzing the content, and using the content for service improvement or the like is performed. For example, there is a need to grasp and collect a so-called “customer's voice” by extracting and analyzing a section in which a client states dissatisfaction and a demand for a provided service from a dialogue. As a different example, there is a need to grasp knowledge of the type of sales performed by excellent operators by classifying and analyzing the contents and types of sections in which the operator is talking about sales in the dialogue, and use the knowledge for education of new operators.

As a conventional technology of classifying a speech section including a single speech or a plurality of speeches, or more generally, a text having a certain length, according to a topic or content thereof, for example, there is a method of using learning data in which information of a classification category is assigned to the speech or the text (see, for example, Non Patent Literature 1). In this method, a model of determining a classification category is generated by performing machine learning using learning data to which classification category information is added.

### CITATION LIST

### Non Patent Literature

Non Patent Literature 1: R.-E. Fan, K.-W. Chang, C.-J. Hsieh, X.-R. Wang, and C.-J. Lin. LIBLINEAR: A library for large linear classification Journal of Machine Learning Research 9(2008), 1871-1874.

### SUMMARY OF INVENTION

### Technical Problem

The above-described conventional technology has the following problems. In a method of assigning a label to each speech, performing machine learning, and learning a classification model by using the assigned label, the speeches in a natural conversation are very short in many cases, and it is difficult to assign a label to each of them. Even if labels can be assigned to each speech, many speeches that do not contribute to the classification of speech sections are often included, and it is difficult to perform classification by a classifier simply on the basis of the assigned labels. That is, in the method of applying all speeches included in the speech section to the classifier, it is not possible to accurately classify the speech in a case where there are many speeches that do not contribute to the classification of the speech section.

The disclosed technology has been made in view of the above points, and an object thereof is to provide a speech section classification device, a speech section classification method, and a speech section classification program capable of accurately classifying a speech section even in a case where speeches included in a speech section include a speech that does not contribute to classification.

### Solution to Problem

A first aspect of the present disclosure is a speech section classification device including: a speech section estimation unit that estimates a speech section from speech text data including speeches of two or more people; a speech type estimation unit that estimates a speech type of each speech included in the speech section estimated by the speech section estimation unit; and a speech section classification unit that classifies the speech section estimated by the speech section estimation unit, using the speech type of each speech estimated by the speech type estimation unit and a speech section classification rule determined in advance as a rule for classifying speech sections on the basis of the speech type.

A second aspect of the present disclosure is a speech section classification method including: estimating a speech section from speech text data including speeches of two or more people; estimating a speech type of each speech included in the speech section that has been estimated; and classifying the speech section that has been estimated, using the speech type of each speech that has been estimated and a speech section classification rule determined in advance as a rule for classifying speech sections on the basis of the speech type.

A third aspect of the present disclosure is a speech section classification program that causes a computer to execute: estimating a speech section from speech text data including speeches of two or more people; estimating a speech type of each speech included in the speech section that has been estimated; and classifying the speech section that has been estimated, using the speech type of each speech that has been estimated and a speech section classification rule determined in advance as a rule for classifying speech sections on the basis of the speech type.

### Advantageous Effects of Invention

According to the disclosed technology, even in a case where speeches included in a speech section include a speech that does not contribute to classification, the speech section can be accurately classified.

### BRIEF DESCRIPTION OF DRAWINGS

FIG. 1 is a block diagram illustrating an example of a hardware configuration of a speech section classification device according to an embodiment.

FIG. 2 is a block diagram illustrating an example of a functional configuration of the speech section classification device according to the embodiment.

FIG. 3 is a diagram illustrating a configuration example of a sentence input unit illustrated in FIG. 2.

FIG. 4 is a diagram illustrating a configuration example of a speech section estimation unit illustrated in FIG. 2.

FIG. 5 is a diagram illustrating a configuration example of a speech type estimation unit illustrated in FIG. 2.

FIG. 6 is a diagram illustrating a configuration example of a speech section classification unit and an output unit illustrated in FIG. 2.

FIG. 7 is a flowchart illustrating an example of a flow of processing in a speech section classification program according to a first embodiment.

FIG. 8 is a flowchart illustrating an example of a flow of speech section classification processing according to the first embodiment, and illustrates an example of a speech section classification rule.

FIG. 9 is a diagram illustrating an example of a speech section classification result according to the first embodiment.

FIG. 10 is a flowchart illustrating an example of a flow of speech section classification processing according to the second embodiment, and illustrates another example of a speech section classification rule.

FIG. 11 is a diagram illustrating an example of a speech section classification result according to the second embodiment.

### DESCRIPTION OF EMBODIMENTS

Hereinafter, an example of an embodiment of the disclosed technology will be described with reference to the drawings. In the drawings, the same or equivalent components and portions will be denoted by the same reference signs. Further, dimensional ratios in the drawings are exaggerated for convenience of description and thus may be different from actual ratios.

### First Embodiment

A speech section classification device according to a first embodiment provides specific improvement over a conventional method of classifying speech sections by subjecting all speeches included in a speech section to a classifier, and indicates improvement in a technical field of classifying speech sections included in a dialogue.

A conventional method of applying all speeches included in the speech section to the classifier has a problem that it is not possible to accurately classify the speech in a case where there are many speeches that do not relate to the classification of the speech section. A conventional method of classifying from the speech section using the information contributing to the classification has a problem that the method of contribution to the final classification is different, and in a case where the contributing information cannot be uniquely determined, accurate classification cannot be performed.

On the other hand, in the present embodiment, the speech type of each speech included in the speech section is estimated, and the speech sections are classified using whether there is a specific type in the estimated speech type, or a combination and an order relationship of a plurality of types. As a result, even in a case where many speeches unrelated to the classification of the speech sections are included, or even in a case where the information contributing to the classification cannot be uniquely determined, the speech sections can be accurately classified.

For example, a speech section illustrated in the following dialog example 1 and dialog example 2 will be considered. The speech content is indicated in “ ”, and the determined speech label is indicated in ( ).

### Dialogue Example 1

First speaker: “Unfortunately, we cannot respond to the inquiry about the line addition.” (operator's negative situation explanation)
Second speaker: “We asked you if we could use two more lines at home and office with the current subscription.” (customer's explanation/answer)
First speaker: “Yes, in your current subscription, the maximum number of available lines is up to five, so you can use only one more line.” (operator's explanation/answer)
Second speaker: “Is that so? I understand.” (customer's explanation/answer)

### Dialogue Example 2

First speaker: “Unfortunately, we cannot respond to the inquiry about the line addition.” (operator's negative situation explanation)
Second speaker: “We asked you if we could use two more lines at home and office with the current subscription.” (customer's explanation/answer)
First speaker: “Yes, in your current subscription, the maximum number of available lines is up to five, so you can use only one more line.” (operator's explanation/answer)
Second speaker: “What? But I heard that it is possible in the previous explanation. Is it really not possible?” (customer's question)

In both the first dialogue example and the second dialogue example, the first to third speeches and the determined speech labels are the same, but only the last speech with respect to this is different. In this example, in the dialogue example 2, the second speaker who is the client expresses a question or a dissatisfaction with the explanation of the first speaker who is the operator, and it is necessary to classify the dialogue example 2 as the customer's voice from the viewpoint of collecting the customer's voice. On the other hand, the dialogue example 1 does not need to be classified as the customer's voice. Furthermore, the second and third speeches do not contribute to the classification. However, in a case where customer's voice is simply determined and classified by a classifier using a speech label, the speech and the speech label included in the dialogue example 1 and the dialogue example 2 are almost the same, and thus, correct classification cannot be performed, and the classification accuracy decreases.

In the present embodiment, a speech section is estimated from speech text data, a speech type is estimated for each speech included in the estimated speech section, and the speech sections are classified using the estimated speech type. By selectively using the speech type according to the classification target, even in a case where a speech included in a speech section includes a speech that does not contribute to classification, the speech section can be accurately classified. The speech text data is a concept that includes one or more speech sections and represents a set of all speeches in one dialogue. The speech section is a concept representing a set of continuous speeches. The speech is a concept representing one separator obtained from voice recognition, text chat, or the like. The speech type is a concept representing the type of speech.

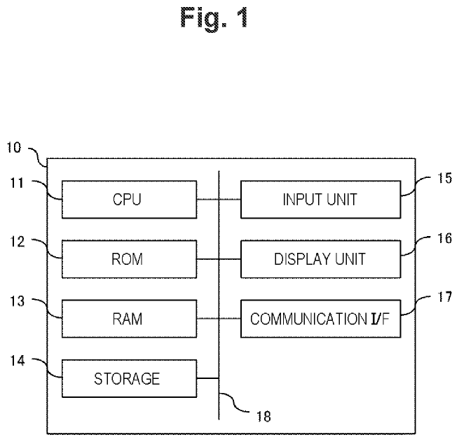

First, a hardware configuration of a speech section classification device 10 according to the present embodiment will be described with reference to FIG. 1.

FIG. 1 is a block diagram illustrating an example of a hardware configuration of the speech section classification device 10 according to the present embodiment.

As illustrated in FIG. 1, the speech section classification device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 18.

The CPU 11 is a central processing unit, which executes various programs and controls each unit. That is, the CPU 11 reads a program from the ROM 12 or the storage 14, and executes the program using the RAM 13 as a working area. The CPU 11 performs control of each of the components described above and various types of calculation processing according to a program stored in the ROM 12 or the storage 14. In the present embodiment, the ROM 12 or the storage 14 stores a speech section classification program for executing speech section classification processing to be described later.

The ROM 12 stores various programs and various types of data. The RAM 13, as a work area, temporarily stores programs or data. The storage 14 includes a hard disk drive (HDD) or a solid state drive (SSD) and stores various programs including an operating system and various types of data.

The input unit 15 includes a pointing device such as a mouse and a keyboard and is used to perform various inputs to the allocation search device.

The display unit 16 is, for example, a liquid crystal display and displays various types of information. The display unit 16 may function as the input unit 15 by adopting a touch panel system.

The communication interface 17 is an interface through which the allocation search device communicates with another external device. The communication is performed in conformity to, for example, a wired communication standard such as Ethernet (registered trademark) or fiber distributed data interface (FDDI) or a wireless communication standard such as 4G, 5G, or Wi-Fi (registered trademark).

For example, a general-purpose computer device such as a server computer or personal computer (PC) is applied to the speech section classification device 10 according to this embodiment.

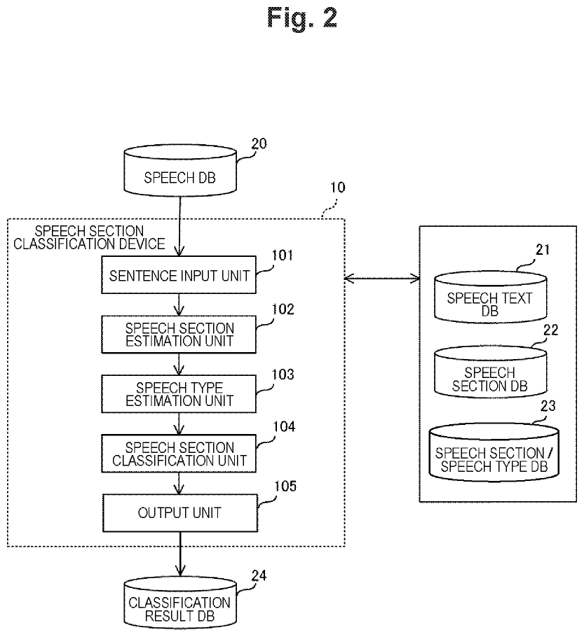

Next, functional configurations of the speech section classification device 10 will be described with reference to FIG. 2.

FIG. 2 is a block diagram illustrating an example of a functional configuration of the speech section classification device 10 according to the present embodiment.

As illustrated in FIG. 2, the speech section classification device 10 includes a sentence input unit 101, a speech section estimation unit 102, a speech type estimation unit 103, a speech section classification unit 104, and an output unit 105 as functional configurations. Each functional configuration is implemented by the CPU 11 reading a speech section classification program stored in the ROM 12 or the storage 14, developing the program in the RAM 13, and executing the program.

Each of the speech database (DB) 20 that stores speech data and the classification result DB 24 that stores classification result data may be stored in the storage 14 or may be stored in an external accessible storage device. As similar to this, each of the speech text DB 21 that stores speech text data, the speech section DB 22 that stores speech section data, and the speech section/speech type DB 23 that stores speech section/speech type data may be stored in the storage 14, or may be stored in an external accessible storage device. In the example of FIG. 2, the speech text data, the speech section data, and the speech section/speech type data are stored in different DBs, but may be stored in one DB.

Hereinafter, as an example, a case will be described in which a negative situation is described by a first speaker who is an operator, and in speech sections in which a second speaker who is a client (hereinafter, also referred to as a “customer”) responds to the explanation, whether these speech sections include “customer's voice” is classified. The “customer's voice” refers to a portion that expresses dissatisfaction or a demand with a service provided to a client or a reception of an operator.

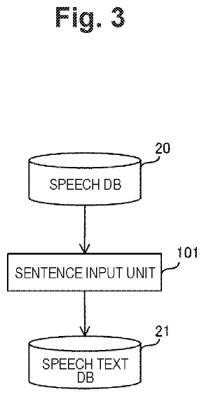

The configuration of each functional unit (sentence input unit 101, speech section estimation unit 102, speech type estimation unit 103, speech section classification unit 104, and output unit 105) illustrated in FIG. 2 will be specifically described with reference to FIGS. 3 to 6.

The sentence input unit 101 illustrated in FIG. 3 acquires speech data from the speech DB 20, and stores speech text data obtained by converting the acquired speech data in the speech text DB 21. The speech data is data including speeches of two or more persons, and may be a character string or a voice. When the speech data is a voice, the sentence input unit 101 converts the speech into text by performing voice recognition and stores the text in the speech text DB 21, and when the speech data is a character string, the text has already been converted into text and thus is stored as it is in the speech text DB 21. As the speech data, for example, the speeches of the above-described dialog examples 1 and 2 are stored in the speech DB 20 as voice, and when the speech data is input as voice, the sentence input unit 101 converts the speech data into text using speech recognition and stores the obtained speech text data in the speech text DB 21.

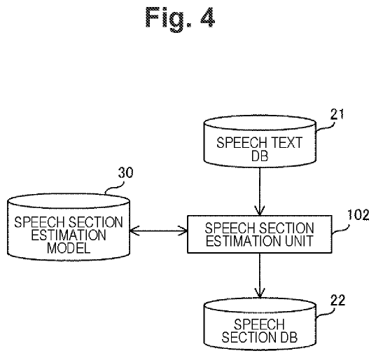

The speech section estimation unit 102 illustrated in FIG. 4 acquires speech text data from the speech text DB 21, and stores speech section data obtained by estimating a speech section from the acquired speech text data in the speech section DB 22. Specifically, when speech text data is input, the speech section estimation unit 102 estimates a speech section using the speech section estimation model 30, and stores the obtained speech section data in the speech section DB 22. The speech section estimation model 30 is a learned model that receives speech text data as input and outputs speech section data. As the speech section estimation model 30, for example, a deep neural network (DNN), which is a multilayered neural network, is used. The speech section estimation model 30 may be stored in the storage 14 or may be stored in an external storage device. As the speech section estimation model 30, for example, a model for determining topic switching is generated by assigning a training label to a speech including a clue word indicating topic switching, such as “then” or “by the way”, and performing machine learning using speech text data to which the training label is assigned as learning data. A speech switching is determined using the speech section estimation model 30, and a speech from a certain switching to the next switching is estimated as a speech section.

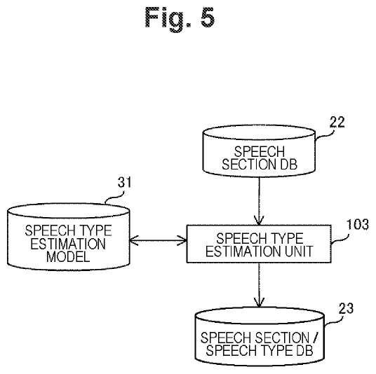

The speech type estimation unit 103 illustrated in FIG. 5 acquires speech section data from the speech section DB 22, and stores the speech section/speech type data obtained by estimating the speech type of each speech included in the acquired speech section data in the speech section/speech type DB 23. Specifically, when the speech section data is input, the speech type estimation unit 103 estimates the speech type of each speech included in the speech section using the speech type estimation model 31, and stores the obtained speech section/speech type data in the speech section/speech type DB 23. The speech type estimation model 31 is a learned model that receives speech section data as input and outputs speech section/speech type data. For example, a DNN is used as the speech type estimation model 31. The speech type estimation model 31 may be stored in the storage 14 or may be stored in an external storage device. As the speech type, for example, the following labels (type 1 to type 9) are defined. A description of each label is shown in < >. A model for classifying these speech types is generated in advance by performing machine learning using speech section data with these labels attached to each speech as learning data. The speech type estimation model 31 is used to estimate the speech type of each speech for the input speech section.
(Type 1) Customer's question<a speech of a question by the customer to the operator>
(Type 2) Customer's explanation/answer<a speech of the customer answering or explaining to the operator's question>
(Type 3) Customer's request/demand<a speech of the customer expressing a request or demand to the operator>
(Type 4) Operator's negative situation<a speech of the operator explaining a negative situation>
(Type 5) Customer's negative situation<a speech of the customer explaining a negative situation>
(Type 6) Operator's negative buffer<a speech of the operator using an expression to soften a negative circumstance>
(Type 7) Customer's positive evaluation<a speech of the customer evaluating using a positive expression>
(Type 8) Customer's negative evaluation<a speech of the customer evaluating using a negative expression>
(Type 9) Issue grasping<a speech related to an issue by the customer or the operator>

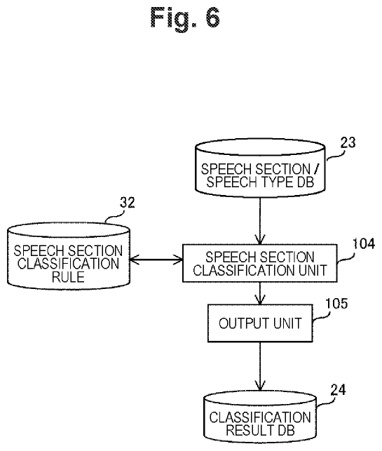

The speech section classification unit 104 illustrated in FIG. 6 acquires the speech section/speech type data from the speech section/speech type DB 23, and classifies the speech section estimated by the speech section estimation unit 102 using the speech type of each speech estimated by the speech type estimation unit 103 and the speech section classification rule 32. The speech section classification rule 32 is predetermined as a rule for classifying speech sections on the basis of speech types. The speech section classification rule 32 classifies speech sections on the basis of whether a specific speech type is included in a speech section, or a combination and order relationship of a plurality of speech types included in a speech section. In the speech section classification processing, it is sufficient that there is one or more speech types estimated from the speech text, and the speech text itself included in the speech section is unnecessary for the processing.

Specifically, when the speech section includes a speech type (type 7) indicating a speech evaluated by the customer using a positive expression or a speech type (type 8) indicating a speech evaluated by the customer using a negative expression, the speech section classification rule 32 classifies the speech section as a section including a portion (that is, “customer's voice”) in which the customer says dissatisfaction or demand. This makes it possible to accurately grasp and collect “customer's voice”.

When the speech section includes a speech type (type 9) indicating a speech of the customer and the operator regarding an issue, and a speech with the speech type (type 9) includes any one of the following types: a speech type (type 1) indicating a speech of a question by the customer to the operator; a speech type (type 3) indicating a speech of which the customer expresses a request or a demand to the operator; a speech type (type 2) indicating a speech that the customer answers or explains to the question of the operator; and a speech type (type 5) indicating a speech of the customer explaining a negative situation, the speech section classification rule 32 classifies the speech section as a section including a portion (that is, “customer's voice”) in which the customer says dissatisfaction or a demand. This makes it possible to accurately grasp and collect “customer's voice” as similar to the case described above.

When the speech section includes a speech type (type 4) indicating a speech of an operator explaining a negative situation or a speech type (type 6) indicating a speech of an operator using an expression for softening a negative circumstance, and any one of the speech type (type 1) indicating a speech of a question by a customer to an operator and the speech type (type 3) indicating a speech of a request or a demand by a customer to an operator is included within two speeches after a speech with the speech type (type 4 or type 6), the speech section classification rule 32 classifies the speech section as a section including a portion (that is, “customer's voice”) in which the customer states dissatisfaction or a demand. This makes it possible to accurately grasp and collect “customer's voice” as similar to the case described above.

The output unit 105 illustrated in FIG. 6 acquires classification result data classified by the speech section classification unit 104, and stores the acquired classification result data in the classification result DB 24.

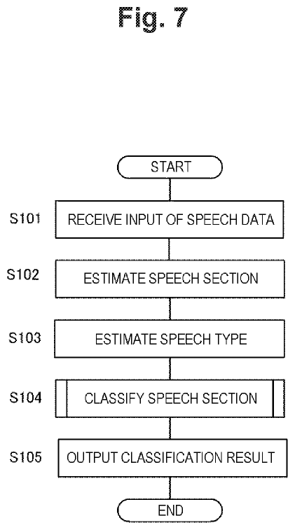

Next, the operation of the speech section classification device 10 according to the first embodiment will be described with reference to FIG. 7.

FIG. 7 is a flowchart illustrating an example of a flow of processing in a speech section classification program according to the first embodiment. The processing by the speech section classification program is implemented by the CPU 11 of the speech section classification device 10 writing the speech section classification program stored in the ROM 12 or the storage 14 into the RAM 13 and executing the program.

In step S101 of FIG. 7, the CPU 11 receives an input of speech data from the speech DB 20, and stores speech text data obtained by converting the received speech data in the speech text DB 21.

In step S102, the CPU 11 acquires speech text data from the speech text DB 21, estimates a speech section corresponding to the acquired speech text data using the speech section estimation model 30, and stores the acquired speech section data in the speech section DB 22.

In step S103, the CPU 11 acquires the speech section data from the speech section DB 22, estimates the speech type corresponding to each speech included in the acquired speech section data using the speech type estimation model 31, and stores the obtained speech section/speech type data in the speech section/speech type DB 23.

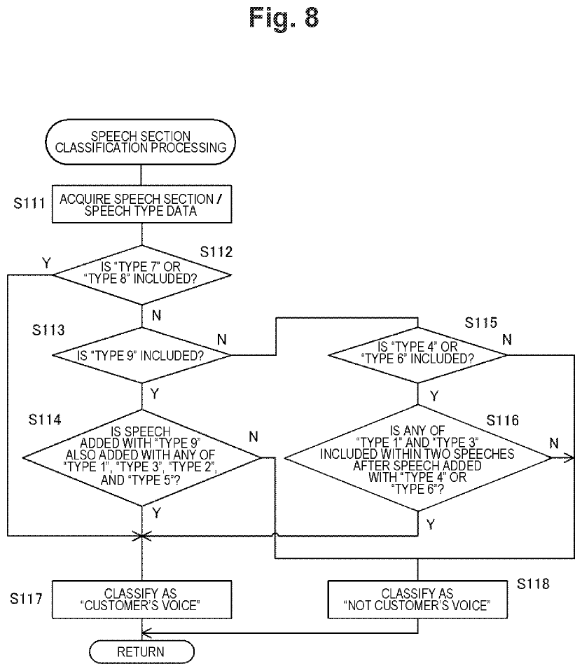

In step S104, the CPU 11 acquires the speech section/speech type data from the speech section/speech type DB 23, and classifies the speech section estimated in step S102 using the speech type of each speech estimated in step S103 and the speech section classification rule 32. A specific example of this speech section classification processing will be described with reference to FIG. 8.

FIG. 8 is a flowchart illustrating an example of a flow of speech section classification processing according to the first embodiment, and illustrates an example of the speech section classification rule 32.

In step S111, the CPU 11 acquires the speech section/speech type data from the speech section/speech type DB 23. As described above, In the speech section classification processing, it is sufficient that there is one or more speech types estimated from the speech text, and the speech text itself included in the speech section is unnecessary.

In step S112, the CPU 11 determines whether the speech types specified from the speech section/speech type data acquired in step S111 include “type 7: customer's positive evaluation” or “type 8: customer's positive evaluation” among the labels of “type 1” to “type 9” described above. When it is determined that “type 7: customer's positive evaluation” or “type 8: customer's negative evaluation” is included (in the case of positive determination), the process proceeds to step S117, and when it is determined that “type 7: customer's positive evaluation” or “type 8: customer's negative evaluation” is not included (in the case of negative determination), the process proceeds to step S113.

In step S113, the CPU 11 determines whether “type 9: issue grasping” is included in the speech type. When it is determined that “type 9: issue grasping” is included (in the case of positive determination), the process proceeds to step S114, and when it is determined that “type 9: issue grasping” is not included (in the case of negative determination), the process proceeds to step S115.

In step S114, the CPU 11 determines whether any one of “type 1: customer's question”, “type 3: customer's request/demand”, “type 2: customer's explanation/answer”, and “type 5: customer's negative situation” is attached to the speech with “type 9: issue grasping”. When it is determined that any type is attached (in the case of positive determination), the process proceeds to step S117, and when it is determined that any type is not attached (in the case of negative determination), the process proceeds to step S118.

In step S115, the CPU 11 determines whether “type 4: operator's negative situation” or “type 6: operator's negative buffer” is included in the speech types. When it is determined that “type 4: operator's negative situation” or “type 6: operator's negative buffer” is included (in the case of positive determination), the process proceeds to step S116, and when it is determined that “type 4: operator's negative situation” or “type 6: operator's negative buffer” is not included (in the case of negative determination), the process proceeds to step S118.

In step S116, the CPU 11 determines whether any one of “type 1: customer's question” and “type 3: customer's request/demand” is included within two speeches after the speech with “type 4: operator's negative situation” or “type 6: operator's negative buffer”. When it is determined that any type is included (in the case of positive determination), the process proceeds to step S117, and when it is determined that any type is not included (in the case of negative determination), the process proceeds to step S118.

In step S117, the speech section specified by the speech section/speech type data is classified as “customer's voice”, and the process returns to step S105 in FIG. 7.

In step S118, the speech section specified by the speech section/speech type data is classified as “not customer's voice”, and the process returns to step S105 in FIG. 7.

Returning to step S105 in FIG. 7, the CPU 11 outputs the classification result data obtained by classifying the speech sections in step S104 to the classification result DB 24, and terminates the series of processing by the speech section classification program.

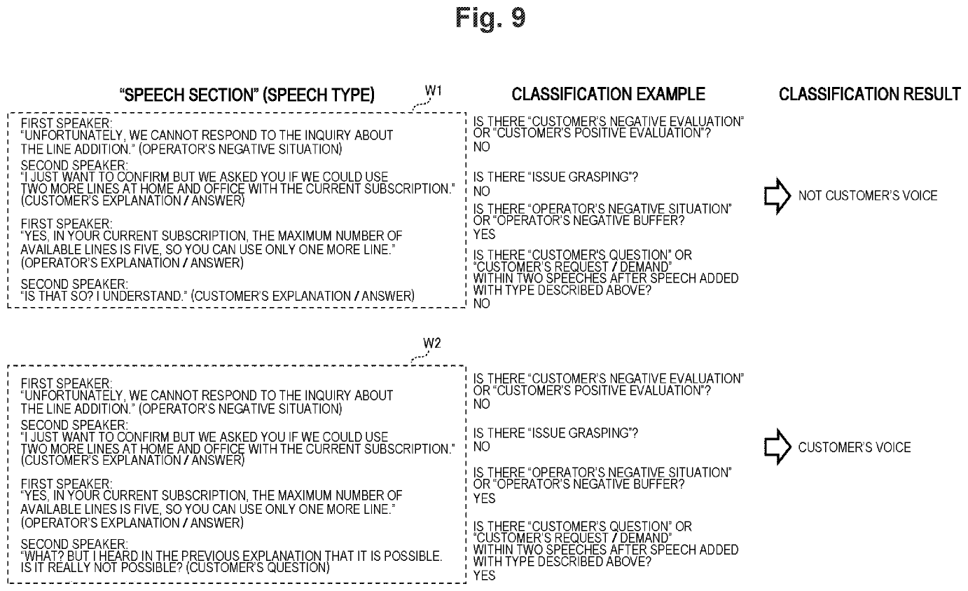

FIG. 9 is a diagram illustrating an example of a speech section classification result according to the first embodiment. The speech section classification result illustrated in FIG. 9 indicates a classification result classified by the speech section classification rule 32 illustrated in FIG. 8 described above.

When the speech section W1 shown in FIG. 9, the speech type of the speech of the first speaker is estimated as “type 4: operator's negative situation”, and the speech type of the speech of the second speaker is estimated as “type 2: customer's explanation/answer”. Next, the speech type of the speech of the first speaker is estimated as “operator's explanation/answer”, and the speech type of the speech of the second speaker is estimated as “type 2: customer's explanation/answer”.

In this case, as shown in the classification example, it is determined whether the speech section W1 includes “type 7: customer's positive evaluation” or “type 8: customer's negative evaluation”. Here, the determination is “NO”. Next, it is determined whether “type 9: issue grasping” is included in the speech section W1. Here, the determination is “NO”. Next, it is determined whether “type 4: operator's negative situation” or “type 6: operator's negative buffer” is included in the speech section W1. Here, the determination is “YES”. Next, it is determined whether any one of “type 1: customer's question” and “type 3: customer's request/demand” is included within two speeches after the speech with “type 4: operator's negative situation” or “type 6: operator's negative buffer”. Here, the determination is “NO”.

In this case, as shown in the classification result, the speech section W1 is classified as “not customer's voice”.

When the speech section W2 shown in FIG. 9, the speech type of the speech of the first speaker is estimated as “type 4: operator's negative situation”, and the speech type of the speech of the second speaker is estimated as “type 2: customer's explanation/answer”. Next, the speech type of the speech of the first speaker is estimated as “operator's explanation/answer”, and the speech type of the speech of the second speaker is estimated as “type 1: customer's question”.

In this case, as shown in the classification example, it is determined whether the speech section W2 includes “type 7: customer's positive evaluation” or “type 8: customer's negative evaluation”. Here, the determination is “NO”. Next, it is determined whether “type 9: issue grasping” is included in the speech section W2. Here, the determination is “NO”. Next, it is determined whether “type 4: operator's negative situation” or “type 6: operator's negative buffer” is included in the speech section W2. Here, the determination is “YES”.

Next, it is determined whether any one of “type 1: customer's question” and “type 3: customer's request/demand” is included within two speeches after the speech with “type 4: operator's negative situation” or “type 6: operator's negative buffer”. Here, the determination is “YES”.

In this case, as shown in the classification result, the speech section W2 is classified as “customer's voice”.

As described above, according to the present embodiment, the speech section is estimated from the speech text data obtained by converting the input speech data, the speech type of each speech included in the speech section is estimated, and the speech section classification is performed using the obtained speech type and speech section classification rule. This makes it possible to accurately classify speech sections necessary for analysis of “customer's voice”.

### Second Embodiment

As similar to the first embodiment described above, a speech section classification device according to a second embodiment provides specific improvement over a conventional method of classifying speech sections by subjecting all speeches included in a speech section to a classifier, and indicates improvement in a technical field of classifying speech sections included in a dialogue.

In the present embodiment, as another example of the speech section classification processing, a case will be described in which a speech section in which an operator is making sales talk is classified using the speech type.

In a contact center, for the purpose of improving the reception quality of the operator, efficiently educating the new operator, and the like, there is an increasing interest in the flow of conversation with the excellent operator, and what is the difference from the non-excellent operator. When an operator conducts a sales dialogue, the need of the client is unknown at the beginning. Therefore, it is assumed that the operator conducts an indefinite inquiry, such as “Is there any problem?”, and conducts an inquiry on specific contents and themes when the need of the client become apparent. In addition, it is assumed that an inquiry specific to the final stage such as “Is there any other problem?” is conducted also at the final stage. That is, in a series of sales dialogue, the way of inquiry need at the beginning is different from the way of inquiry at the middle and final stages of the dialogue. Therefore, it is conceivable to classify speech sections into three types as targets of classification: an “open type sales section” that is a section in which a dialogue that is not focused on a specific topic or theme is performed, a “theme type sales section” that is a section in which a dialogue related to a specific topic or theme is performed, and an “end type sales section” that is a section in which the presence or absence of another topic or theme is confirmed. More specifically for the three types of classification, it is conceivable that classification is performed into three types: an “open type sales section” that is a section in which dialogue is performed so as to ask for an indefinite need without referring to a specific service or topic; a “theme type sales section” that is a section in which sales talk is specifically performed for a specific service or topic; and an “end type sales section” that is a section in which dialogue is performed so as to make a user feel the closing of dialogue regarding a specific service or topic or confirm the presence or absence of other need.

The components of the speech section classification device (hereinafter, referred to as the speech section classification device 10A) according to the second embodiment are the same as the components of the speech section classification device 10 according to the first embodiment. That is, the speech section classification device 10A includes a sentence input unit 101, a speech section estimation unit 102, a speech type estimation unit 103, a speech section classification unit 104, and an output unit 105 that are described above, as functional configurations. Repeated description of the sentence input unit 101, the speech section estimation unit 102, and the output unit 105 will be omitted.

As illustrated in FIG. 5 described above, when the speech section data is input, the speech type estimation unit 103 estimates the speech type of each speech included in the speech section using the speech type estimation model 31, and stores the obtained speech section/speech type data in the speech section/speech type DB 23. The speech type estimation model 31 is a learned model that receives speech section data as input and outputs speech section/speech type data. As the speech type, for example, the following labels (type 11 to type 16) are defined. A model for classifying these speech types is generated in advance by performing machine learning using learning data attached with these labels. The speech type estimation model 31 is used to estimate the speech type for the input speech section. The open question is a question that is mainly made at the beginning of a dialogue and asks for a need. For example, a question that does not refer to a particular service or topic, such as “What are you looking for?”, and indefinitely asks for a need. A theme question is a question about a specific topic or theme that is mainly made in the middle of a dialogue. The theme question is a question other than an open question and an end question, such as a question that specifically conducts a asking about a need for a specific service or topic. The end question is a question for confirming the presence or absence of other topics or themes, which is mainly conducted at the end of a dialogue. The end question is a question that makes the user feel the end of a conversation about a specific topic, while asking for the presence or absence of other need in an indefinite manner.
(Type 11) Operator's asking about a need/open question
(Type 12) Operator's asking about a need/theme question
(Type 13) Operator's asking about a need/end question
(Type 14) Operator's proposal
(Type 15) Operator's answer
(Type 16) Customer's answer

As illustrated in FIG. 6 described above, the speech section classification unit 104 acquires the speech section/speech type data from the speech section/speech type DB 23, and classifies the speech section estimated by the speech section estimation unit 102 using the speech type of each speech estimated by the speech type estimation unit 103 and the speech section classification rule 32.

Specifically, when the speech section includes a speech type (hereinafter, also referred to as “asking-about-need speech”.) indicating a speech of an operator asking about a need of the customer, and the speech type of the inquiry for the first need in the inquiry section is an open question (type 11), the speech section classification rule 32 classifies the speech section as an open type sales section. When the speech section includes the “asking-about-need speech” and the speech type of the first asking of the need in the speech section is a theme question (type 12), the speech section classification rule 32 classifies the speech section as a theme type sales section. When the speech section includes the “asking-about-need speech” and the speech type of the first asking of the need in the speech section is an end question (type 13), the speech section classification rule 32 classifies the speech section as an end type sales section. As a result, the speech section including the sales talk of the operator can be accurately grasped and collected according to the content thereof.

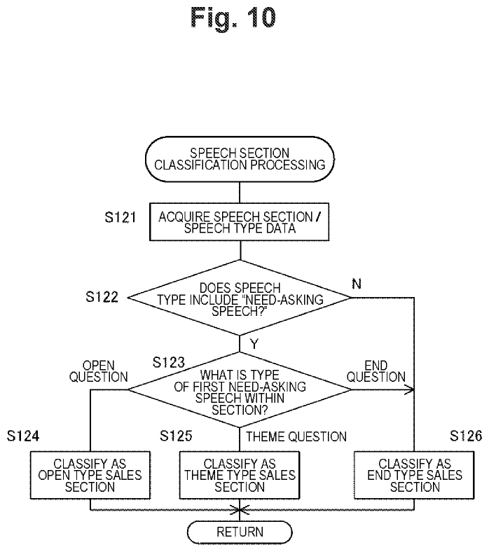

Next, the speech section classification processing according to the second embodiment will be described with reference to FIG. 10. As described above, In the speech section classification processing, it is sufficient that there is one or more speech types estimated from the speech text, and the speech text itself included in the speech section is unnecessary for the processing.

FIG. 10 is a flowchart illustrating an example of a flow of speech section classification processing according to the second embodiment, and illustrates another example of the speech section classification rule 32.

In step S121, the CPU 11 acquires the speech section/speech type data from the speech section/speech type DB 23.

In step S122, the CPU 11 determines whether the speech types identified from the speech section/speech type data acquired in step S121 include the “asking-about-need speech” among the labels “type 11” to “type 16” described above. When it is determined that the “asking-about-need speech” is included (in the case of positive determination), the process proceeds to step S123, and when it is determined that the “asking-about-need speech” is not included (in the case of negative determination), the process proceeds to step S126.

In step S123, the CPU 11 determines the speech type of the first asking-about-need speech within the speech section. When the “type 11: operator's asking about a need/open question” is determined, the process proceeds to step S124. When the “type 12: operator's asking about a need/theme question” is determined, the process proceeds to step S125. When the “type 13: operator's asking about a need/end question” is determined, the process proceeds to step S126.

In step S124, the CPU 11 classifies the speech section identified by the speech section/speech type data into an “open type sales section”, and returns to step S105 in FIG. 7 described above.

In step S125, the CPU 11 classifies the speech section identified by the speech section/speech type data into an “theme type sales section”, and returns to step S105 in FIG. 7 described above.

In step S126, the CPU 11 classifies the speech section identified by the speech section/speech type data into an “end type sales section”, and returns to step S105 in FIG. 7 described above.

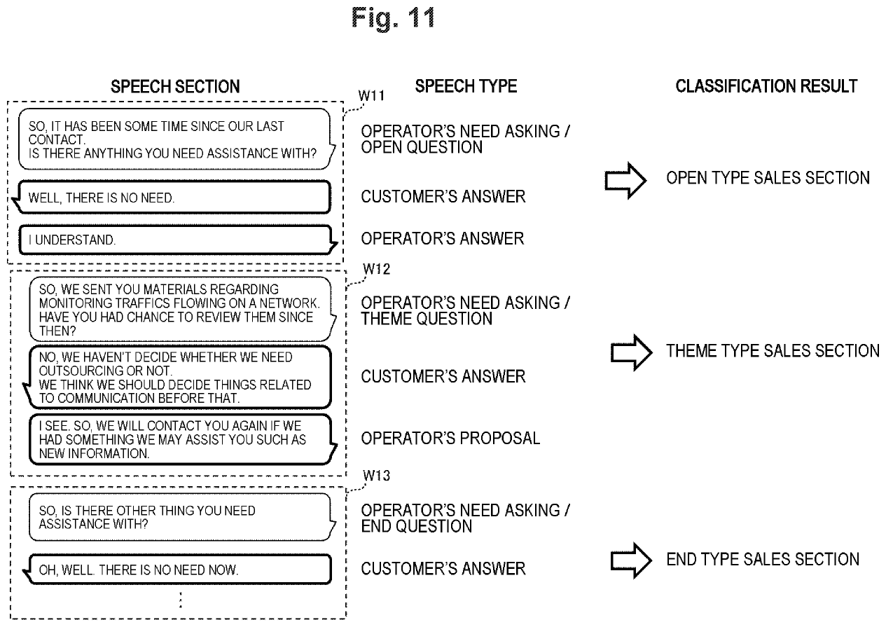

FIG. 11 is a diagram illustrating an example of a speech section classification result according to the second embodiment. The speech section classification result illustrated in FIG. 11 indicates a classification result classified by the speech section classification rule 32 illustrated in FIG. 10 described above.

In the case of the speech section W11 illustrated in FIG. 11, the speech type of the speech of the operator is estimated as “type 11: operator's asking about a need/open question”, the speech type of the speech of the customer is estimated as “type 16: customer's answer”, and the speech type of the speech of the operator is estimated as “type 15: operator's answer”.

In this case, as shown in the classification result, the speech section W11 is classified as “open type sales section”.

In the case of the speech section W12 illustrated in FIG. 11, the speech type of the speech of the operator is estimated as “type 12: operator's asking about a need/theme question”, the speech type of the speech of the customer is estimated as “type 16: customer's answer”, and the speech type of the speech of the operator is estimated as “type 14: operator's suggestion”.

In this case, as shown in the classification result, the speech section W12 is classified as “theme type sales section”.

In the case of the speech section W13 illustrated in FIG. 11, the speech type of the speech of the operator is estimated as “type 13: operator's asking about a need/end question”, the speech type of the speech of the customer is estimated as “type 16: customer's answer”.

In this case, as shown in the classification result, the speech section W13 is classified as “end type sales section”.

As described above, according to the present embodiment, the speech section is estimated from the speech text data obtained by converting the input speech data, the speech type of each speech included in the speech section is estimated, and the speech section classification is performed using the obtained speech type and speech section classification rule. As a result, it is possible to accurately perform the classification of the sales section useful for the analysis of the excellent reception in the contact center.

As described above, even when it is conventionally difficult to perform accurate classification, the speech section can be accurately classified by estimating the speech type for each speech included in the speech section and selectively using the estimated speech type according to the purpose of classification.

As for the method for estimating the speech section, the speech section may be estimated by any of the following methods in addition to the methods described above.
(Method 1) Predetermined N (N is 2 or more) speeches are grouped into one speech section.
(Method 2) One input speech text data, that is, one speech is set as one speech section.

Note that the speech section classification processing executed by the CPU 11 reading the speech section classification program in the above embodiment may be executed by various processors other than the CPU 11. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). In addition, the speech section classification processing may be executed by one of these various processors or may be executed by a combination of the same processors or two or more different types of processors (for example, a plurality of FPGAs, a combination of a CPU and an FPGA, or the like). More specifically, a hardware structure of the various processors is an electric circuit in which circuit elements such as semiconductor elements are combined.

Further, in each of the above embodiments, the aspect in which the speech section classification program is stored (also referred to as “installed”) in advance in the ROM 12 or the storage 14 has been described, but the present embodiment is not limited thereto. The speech section classification program may be provided in the form of a program stored in a non-transitory storage medium such as a compact disk read only memory (CD-ROM), a digital versatile disk read only memory (DVD-ROM), or a universal serial bus (USB) memory. In addition, the speech section classification program may be downloaded from an external device via a network.

All documents, patent applications, and technical standards described in this specification are incorporated herein by reference to the same extent as in a case where a case where incorporation by reference of each document, patent application, and technical standard is specifically and individually described.

Regarding the above embodiments, the following supplementary notes are further disclosed herein.

### Supplementary 1

A speech section classification device including
a memory, and
at least one processor connected to the memory,
in which the processor
estimates a speech section from speech text data including speeches of two or more people,
estimates a speech type of each speech included in the speech section that has been estimated, and
classifies a speech section that has been estimated, using a speech section classification rule determined in advance as a rule for classifying speech sections on the basis of the speech type of each speech that has been estimated and the speech type.

### Supplement 2

A non-transitory storage medium storing a program executable by a computer to perform speech section classification processing,
the speech section classification processing including:
estimating a speech section from speech text data including speeches of two or more people; estimating a speech type of each speech included in the speech section that has been estimated; and
classifying a speech section that has been estimated, using a speech section classification rule determined in advance as a rule for classifying speech sections on the basis of the speech type of each speech that has been estimated and the speech type.

### REFERENCE SIGNS LIST

10 Speech section classification device
11 CPU
12 ROM
13 RAM
14 Storage
15 Input unit
16 Display unit
17 Communication I/F
18 Bus
20 Speech DB
21 Speech text DB
22 Speech section DB
23 Speech section/speech type DB
24 Classification result DB
30 Speech section estimation model
31 Speech type estimation model
32 Speech section classification rule
101 Sentence input unit
102 Speech section estimation unit
103 Speech type estimation unit
104 Speech section classification unit
105 Output unit

1. A speech section classification device comprising:
a speech section estimation unit that estimates a speech section from speech text data including speeches of two or more people;
a speech type estimation unit that estimates a speech type of each speech included in the speech section estimated by the speech section estimation unit; and
a speech section classification unit that classifies the speech section estimated by the speech section estimation unit, using the speech type of each speech estimated by the speech type estimation unit and a speech section classification rule determined in advance as a rule for classifying speech sections based on the speech type.

2. The speech section classification device according to claim 1,
wherein, in the speech section classification rule, whether a specific speech type is included in the speech section, or a combination and order relationship of a plurality of speech types included in the speech section is defined.

3. The speech section classification device according to claim 2,
wherein the speech text data includes a speech of an operator and a speech of a client, and
when the speech section includes a speech type indicating a speech of the client evaluating using a positive expression or a speech type indicating a speech of the client evaluating using a negative expression, the speech section classification rule classifies the speech section as a section including dissatisfaction or a demand of the client.

4. The speech section classification device according to claim 2,
wherein the speech text data includes a speech of an operator and a speech of a client, and,
when the speech section includes a speech type indicating a speech of the client and the operator regarding an issue, and a speech with the speech type is added with any one of the following types: a speech type indicating a speech of a question by the client to the operator; a speech type indicating a speech of the client expressing a request or a demand to the operator; a speech type indicating a speech of the client answering or explaining to the question of the operator; and a speech type indicating a speech of the client explaining a negative situation, the speech section classification rule classifies the speech section as a section including dissatisfaction or a demand of the client.

5. The speech section classification device according to claim 2,
wherein the speech text data includes a speech of an operator and a speech of a client, and,
when the speech section includes a speech type indicating a speech of the operator explaining a negative situation or a speech type indicating a speech of the operator using an expression for softening a negative circumstance, and any one of a speech type indicating a speech of a question by the client to the operator and a speech type indicating a speech of the client expressing a request or a demand to the operator is included within two speeches after a speech added with the speech type, the speech section classification rule classifies the speech section as a section including a dissatisfaction or a demand of the client.

6. The speech section classification device according to claim 2,
wherein the speech text data includes a speech of an operator and a speech of a client, and,
when the speech section includes a speech type indicating a speech of the operator asking about a need of the client, and the speech type of the first asking of the need in the speech section is an open question, the speech section classification rule classifies the speech section as an open type sales section,
when the speech section includes a speech type indicating a speech of the operator asking about the need of the client, and the speech type of the first asking of the need in the speech section is a theme question, the speech section classification rule classifies the speech section as a theme type sales section, and
when the speech section includes the speech type indicating a speech of the operator asking about the need of the client, and the speech type of the first asking of the need in the speech section is an end question, the speech section classification rule classifies the speech section as an end type sales section.

7. A speech section classification method comprising:
estimating a speech section from speech text data including speeches of two or more people;
estimating a speech type of each speech included in the speech section that has been estimated; and
classifying the speech section that has been estimated, using the speech type of each speech that has been estimated and a speech section classification rule determined in advance as a rule for classifying speech sections based on the speech type.

8. A speech section classification program that causes a computer to execute:
estimating a speech section from speech text data including speeches of two or more people;
estimating a speech type of each speech included in the speech section that has been estimated; and
classifying the speech section that has been estimated, using the speech type of each speech that has been estimated and a speech section classification rule determined in advance as a rule for classifying speech sections based on and the speech type.

9. The speech section classification method according to claim 7,
wherein, in the speech section classification rule, whether a specific speech type is included in the speech section, or a combination and order relationship of a plurality of speech types included in the speech section is defined.

10. The speech section classification method according to claim 7,
wherein the speech text data includes a speech of an operator and a speech of a client, and
when the speech section includes a speech type indicating a speech of the client evaluating using a positive expression or a speech type indicating a speech of the client evaluating using a negative expression, the speech section classification rule classifies the speech section as a section including dissatisfaction or a demand of the client.

11. The speech section classification method according to claim 7,
wherein the speech text data includes a speech of an operator and a speech of a client, and,
when the speech section includes a speech type indicating a speech of the client and the operator regarding an issue, and a speech with the speech type is added with any one of the following types: a speech type indicating a speech of a question by the client to the operator; a speech type indicating a speech of the client expressing a request or a demand to the operator; a speech type indicating a speech of the client answering or explaining to the question of the operator; and a speech type indicating a speech of the client explaining a negative situation, the speech section classification rule classifies the speech section as a section including dissatisfaction or a demand of the client.

12. The speech section classification method according to claim 7,
wherein the speech text data includes a speech of an operator and a speech of a client, and,
when the speech section includes a speech type indicating a speech of the operator explaining a negative situation or a speech type indicating a speech of the operator using an expression for softening a negative circumstance, and any one of a speech type indicating a speech of a question by the client to the operator and a speech type indicating a speech of the client expressing a request or a demand to the operator is included within two speeches after a speech added with the speech type, the speech section classification rule classifies the speech section as a section including a dissatisfaction or a demand of the client.

13. The speech section classification method according to claim 7,
wherein the speech text data includes a speech of an operator and a speech of a client, and,
when the speech section includes a speech type indicating a speech of the operator asking about a need of the client, and the speech type of the first asking of the need in the speech section is an open question, the speech section classification rule classifies the speech section as an open type sales section,
when the speech section includes a speech type indicating a speech of the operator asking about the need of the client, and the speech type of the first asking of the need in the speech section is a theme question, the speech section classification rule classifies the speech section as a theme type sales section, and
when the speech section includes the speech type indicating a speech of the operator asking about the need of the client, and the speech type of the first asking of the need in the speech section is an end question, the speech section classification rule classifies the speech section as an end type sales section.

14. The speech section classification program according to claim 8,
wherein, in the speech section classification rule, whether a specific speech type is included in the speech section, or a combination and order relationship of a plurality of speech types included in the speech section is defined.

15. The speech section classification program according to claim 8,
wherein the speech text data includes a speech of an operator and a speech of a client, and
when the speech section includes a speech type indicating a speech of the client evaluating using a positive expression or a speech type indicating a speech of the client evaluating using a negative expression, the speech section classification rule classifies the speech section as a section including dissatisfaction or a demand of the client.

16. The speech section classification program according to claim 8,
wherein the speech text data includes a speech of an operator and a speech of a client, and,
when the speech section includes a speech type indicating a speech of the client and the operator regarding an issue, and a speech with the speech type is added with any one of the following types: a speech type indicating a speech of a question by the client to the operator; a speech type indicating a speech of the client expressing a request or a demand to the operator; a speech type indicating a speech of the client answering or explaining to the question of the operator; and a speech type indicating a speech of the client explaining a negative situation, the speech section classification rule classifies the speech section as a section including dissatisfaction or a demand of the client.

17. The speech section classification program according to claim 8,
wherein the speech text data includes a speech of an operator and a speech of a client, and,
when the speech section includes a speech type indicating a speech of the operator explaining a negative situation or a speech type indicating a speech of the operator using an expression for softening a negative circumstance, and any one of a speech type indicating a speech of a question by the client to the operator and a speech type indicating a speech of the client expressing a request or a demand to the operator is included within two speeches after a speech added with the speech type, the speech section classification rule classifies the speech section as a section including a dissatisfaction or a demand of the client.

18. The speech section classification program according to claim 8,
wherein the speech text data includes a speech of an operator and a speech of a client, and,
when the speech section includes a speech type indicating a speech of the operator asking about a need of the client, and the speech type of the first asking of the need in the speech section is an open question, the speech section classification rule classifies the speech section as an open type sales section,
when the speech section includes a speech type indicating a speech of the operator asking about the need of the client, and the speech type of the first asking of the need in the speech section is a theme question, the speech section classification rule classifies the speech section as a theme type sales section, and
when the speech section includes the speech type indicating a speech of the operator asking about the need of the client, and the speech type of the first asking of the need in the speech section is an end question, the speech section classification rule classifies the speech section as an end type sales section.

19. The speech section classification device according to claim 1, wherein a speech segment estimation unit estimates a speech segment using a speech segment estimation model in which the speech segment estimation model is a trained model that receives speech text data and outputs speech segment data.

20. The speech section classification device according to claim 1, wherein a classifying model for utterance types is generated in advance by performing machine learning using utterance segment data with labels attached to each utterance as learning data.
